(19) United States
(12) Patent Application Publication
(10) Pub. No.: US 2022/0306960 A1
(43) Pub. Date: Sep. 29, 2022

(54) New Additive Packages for Gasoline Fuels

(71) Applicant: BASF SE, Ludwigshafen am Rhein (DE)

(72) Inventors: Markus Hansch, Ludwigshafen (DE); Jochen Mezger, Ludwigshafen (DE); Jan Ole Mueller, Ludwigshafen (DE); Aaron Flores-Figueroa, Ludwigshafen (DE)

(73) Assignee: BASF SE, Ludwigshafen am Rhein (DE)

(21) Appl. No.: 17/596,904

(22) PCT Filed: Jun. 16, 2020
(86) PCT No.: PCT/EP2020/066563

§ 371 Date: Dec. 21, 2021

(30) Foreign Application Priority Data
Jun. 26, 2019 (EP) 19182517.3

(51) Int. Cl. C10L 10/04; C10L 1/196; C10L 10/18; C08F 222/06; C08F 210/14; C08F 8/32; C10L 1/236; F02M 65/00; F02B 5/02

(52) U.S. Cl. CPC C10L 10/04; C10L 1/196; C10L 10/18; C08F 222/06; C08F 210/14; C08F 8/32; C10L 1/2366; F02M 65/008; F02B 5/02; C10L 2270/023

(57) ABSTRACT

Novel compounds can be used as additive packages for improving the cleanliness of direct injection spark ignition (DISI) engines.

The present invention relates to novel compounds as additive packages for improving the cleanliness of direct injection spark ignition (DISI) engines.

Certain compounds bearing dialkylamino groups for reducing injector deposits in direct injection gasoline engines are known from the prior art.

EP 1293553 A2 discloses compounds bearing dialkylamino alkyl groups, such as hexahydro-1,3,5-triazine derivatives, amides or Mannich products. It is a disadvantage of those compounds that formulations with standard gasoline fuel additives lack storage stability and form deposits during storage (see example section).

The deposits formed as a result of this precipitation can additionally impair the working of engines, engine constituents or parts of the fuel system, especially the injection system, specifically the injection pumps or nozzles.

The “injection system” is understood to mean the part of the fuel system in motor vehicles from the fuel pump up to and including the injector outlet. “Fuel system” is understood to mean the components of motor vehicles that are in contact with the particular fuel, preferably the region from the tank up to and including the injector outlet.

WO 11/161149 discloses copolymers bearing quaternary ammonium groups for fuel additives, preferably diesel fuels.

A copolymer bearing repeatitive N-(-3-dimethylaminopropyl) succinimide units was used for quaternisation, however, the non-quaternised copolymer was not used as fuel additive.

The problem addressed was therefore that of providing compounds for the reduction or inhibition of injector deposits in DISI engines which form stable formulations with commonly used additive compounds.

In one embodiment of the present invention, the inventive compounds counteract deposits not just in the injection system but also in the rest of the fuel system, here especially deposits in fuel filters and pumps.

Accordingly, the invention provides the use of copolymers obtainable by
in a first reaction step (I) copolymerizing
(A) at least one ethylenically unsaturated dicarboxylic acid or derivatives thereof, preferably an anhydride of a dicarboxylic acid,
(B) at least one α-olefin having from at least 12 up to and including 30 carbon atoms,
(C) optionally at least one further aliphatic or cycloaliphatic olefin which has at least 4 carbon atoms and is different than (B) and
(D) optionally one or more further copolymerizable monomers other than monomers (A), (B) and (C), selected from the group consisting of
(Da) vinyl esters,
(db) vinyl ethers,
(Dc) (meth)acrylic esters of alcohols having at least 5 carbon atoms,
(Dd) allyl alcohols or ethers thereof,
(De) N-vinyl compounds selected from the group consisting of vinyl compounds of heterocycles containing at least one nitrogen atom, N-vinylamides or N-vinyllactams,
(Df) ethylenically unsaturated aromatics,
(Dg) α,β-ethylenically unsaturated nitriles,
(Dh) (meth)acrylamides and
(Di) allylamines,

followed by
in a second reaction step (II) reacting the copolymer obtainable from reaction step (I) with at least one amino compound of formula (I)

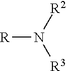

wherein

R is hydrogen (H) or a group —R¹—X—H, wherein

R¹ is a divalent alkylene group comprising 2 to 6 carbon atoms, optionally interrupted by (O) oxygen, NH and/or NR⁴ groups, and/or optionally bearing at least one further substituents, preferably selected from the group consisting of alkyl, alkyloxy, aryl, hydroxy, amino and mono- or dialkylated amino groups,

R² and R³ are independently of another C₁- to C₂₀-alkyl, C₆- to C₁₀-aryl, C₅- to C₁₂-cycloalkyl, or C₇- to C₁₁-aralkyl, wherein R² and R³ together with the nitrogen atom may form a cycloaliphatic or aromatic ring in which further hetero atoms may be incorporated,

X means O (oxygen), NH or NR⁴, and

R⁴ is C₁- to C₄-alkyl or C₆- to C₁₀-aryl, preferably C₁- to C₄-alkyl and very preferably methyl, followed by
in a third optional reaction step (III) partly or fully hydrolyzing anhydride functionalities—if any—present in the copolymer obtained from (II),

for controlling injector deposits in a direct injection spark ignition engine.

The copolymers described are found to be particularly advantageous in gasoline fuels.

Description of the Copolymer

The monomer (A) is at least one, preferably one to three, more preferably one or two and most preferably exactly one ethylenically unsaturated, preferably α,β-ethylenically unsaturated, dicarboxylic acid(s) or derivatives thereof, preferably an anhydride of a dicarboxylic acid.

Derivatives are Understood to Mean
the corresponding anhydrides in monomeric or else polymeric form,
mono- or dialkyl esters, preferably mono- or di-C₁-C₄-alkyl esters, more preferably mono- or dimethyl esters or the corresponding mono- or diethyl esters, and
mixed esters, preferably mixed esters having different C₁-C₄ alkyl components, more preferably mixed methyl ethyl esters.

Preferably, the derivatives are anhydrides in monomeric form or di-C₁-C₄-alkyl esters, more preferably anhydrides in monomeric form.

In the context of this document, C₁-C₄-alkyl is understood to mean methyl, ethyl, iso-propyl, n-propyl, n-butyl, iso-butyl, sec-butyl and tert-butyl, preferably methyl and ethyl, more preferably methyl.

Examples of α,β-ethylenically unsaturated dicarboxylic acids are those dicarboxylic acids or derivatives thereof in which at least one carboxyl group, preferably both carboxyl groups, is/are conjugated to the ethylenically unsaturated double bond.

Examples of ethylenically unsaturated dicarboxylic acids that are not α,β-ethylenically unsaturated are cis-5-norbornene-endo-2,3-dicarboxylic anhydride, exo-3,6-epoxy-1,2,3,6-tetrahydrophthalic anhydride and cis-4-cyclohexene-1,2-dicarboxylic anhydride.

Examples of dicarboxylic acids are maleic acid, fumaric acid, itaconic acid (2-methylenebutanedioic acid), citraconic acid (2-methylmaleic acid), glutaconic acid (pent-2-ene-1,5-dicarboxylic acid), 2,3-dimethylmaleic acid, 2-methylfumaric acid, 2,3-dimethylfumaric acid, methylenemalonic acid and tetrahydrophthalic acid, preferably maleic acid and fumaric acid and more preferably maleic acid and derivatives thereof.

More particularly, monomer (A) is maleic anhydride.

Monomer (B) is at least one, preferably one to four, more preferably one to three, even more preferably one or two and most preferably exactly one α-olefin(s) having from at least 12 up to and including 30 carbon atoms. The α-olefins (B) preferably have at least 14, more preferably at least 16 and most preferably at least 18 carbon atoms. Preferably, the α-olefins (B) have up to and including 28, more preferably up to and including 26 and most preferably up to and including 24 carbon atoms.

Preferably, the α-olefins may be linear or branched, preferably linear, 1-alkenes.

Examples of these are 1-dodecene, 1-tridecene, 1-tetradecene, 1-pentadecene, 1-hexadecene, 1-heptadecene, 1-octadecene, 1-nonodecene, 1-eicosene, 1-docosene, 1-tetracosene, 1-hexacosene, preference being given to 1-octadecene, 1-eicosene, 1-docosene and 1-tetracosene, and mixtures thereof.

Further examples of α-olefin (B) are those olefins which are oligomers or polymers of C₂ to C₁₂ olefins, preferably of C₃ to C₁₀ olefins, more preferably of C₃ to C₄ olefins. Examples thereof are ethene, propene, 1-butene, 2-butene, isobutene, pentene isomers and hexene isomers, preference being given to ethene, propene, 1-butene, 2-butene and isobutene.

Named examples of α-olefins (B) include oligomers and polymers of propene, 1-butene, 2-butene, isobutene, and mixtures thereof, particularly oligomers and polymers of propene or isobutene or of mixtures of 1-butene and 2-butene, more particularly of isobutene. Among the oligomers, preference is given to the trimers, tetramers, pentamers and hexamers, and mixtures thereof.

In addition to the olefin (B), it is optionally possible to incorporate at least one, preferably one to four, more preferably one to three, even more preferably one or two and especially exactly one further aliphatic or cycloaliphatic olefin(s) (C) which has/have at least 4 carbon atoms and is/are different than (B) by polymerization into the inventive copolymer.

The olefins (C) may be olefins having a terminal (α-)double bond or those having a non-terminal double bond, preferably having an α-double bond. The olefin (C) preferably comprises olefins having 4 to fewer than 12 or more than 30 and up to 350 carbon atoms. If the olefin (C) is an olefin having 12 to 30 carbon atoms, this olefin (C) does not have an α-double bond.

Examples of aliphatic olefins (C) are 1-butene, 2-butene, isobutene, pentene isomers, hexene isomers, heptene isomers, octene isomers, nonene isomers, decene isomers, undecene isomers and mixtures thereof.

Examples of cycloaliphatic olefins (C) are cyclopentene, cyclohexene, cyclooctene, cyclodecene, cyclododecene, α- or β-pinene and mixtures thereof, limonene and norbornene.

Further examples of olefins (C) having more than 30 carbon atoms are polymers of propene, 1-butene, 2-butene or isobutene or of olefin mixtures comprising the latter, preferably of isobutene or of olefin mixtures comprising the latter, more preferably having a mean molecular weight M_{w} in the range from 500 to 5000 g/mol, preferably 650 to 3000 and more preferably 800 to 1500 g/mol.

Preferably, the oligomers or polymers comprising isobutene in copolymerized form have a high content of terminal ethylenic double bonds (α-double bonds), for example at least 50 mol %, preferably at least 60 mol %, more preferably at least 70 mol % and most preferably at least 80 mol %.

For the preparation of such oligomers or polymers comprising isobutene in copolymerized form, suitable isobutene sources are either pure isobutene or isobutene-containing C4 hydrocarbon streams, for example C4 raffinates, especially “raffinate 1”, C4 cuts from isobutane dehydrogenation, C4 cuts from steamcrackers and from FCC crackers (fluid catalyzed cracking), provided that they have substantially been freed of 1,3-butadiene present therein. A C4 hydrocarbon stream from an FCC refinery unit is also known as a “b/b” stream. Further suitable isobutene-containing C4 hydrocarbon streams are, for example, the product stream of a propyleneisobutane cooxidation or the product stream from a metathesis unit, which are generally used after customary purification and/or concentration. Suitable C4 hydrocarbon streams comprise generally less than 500 ppm, preferably less than 200 ppm, of butadiene. The presence of 1-butene and of cis- and trans-2-butene is substantially uncritical. Typically, the isobutene concentration in said C4 hydrocarbon streams is in the range from 40% to 60% by weight. For instance, raffinate 1 generally consists essentially of 30% to 50% by weight of isobutene, 10% to 50% by weight of 1-butene, 10% to 40% by weight of cis- and trans-2-butene and 2% to 35% by weight of butanes; in the polymerization process of the invention, the unbranched butenes in the raffinate 1 are generally virtually inert, and only the isobutene is polymerized.

In a preferred embodiment, the monomer source used for polymerization is a technical C4 hydrocarbon stream having an isobutene content of 1% to 100% by weight, especially of 1% to 99% by weight, in particular of 1% to 90% by weight, more preferably of 30% to 60% by weight, especially a raffinate 1 stream, a b/b stream from an FCC refinery unit, a product stream from a propylene-isobutane cooxidation or a product stream from a metathesis unit.

It is also possible, albeit less preferable, to convert monomer mixtures of isobutene or of the isobutene-containing hydrocarbon mixture with olefinically unsaturated monomers copolymerizable with isobutene. If monomer mixtures of isobutene with suitable comonomers are to be copolymerized, the monomer mixture comprises preferably at least 5% by weight, more preferably at least 10% by weight and especially at least 20% by weight of isobutene, and preferably at most 95% by weight, more preferably at most 90% by weight and especially at most 80% by weight of comonomers.

In a preferred embodiment, the mixture of the olefins (B) and optionally (C), averaged to their molar amounts, have at least 12 carbon atoms, preferably at least 14, more preferably at least 16 and most preferably at least 17 carbon atoms.

For example, a 2:3 mixture of docosene and tetradecene has an averaged value for the carbon atoms of 0.4×22+0.6×14=17.2.

The upper limit is less relevant and is generally not more than 60 carbon atoms, preferably not more than 55, more preferably not more than 50, even more preferably not more than 45 and especially not more than 40 carbon atoms.

The optional monomer (D) is at least one monomer, preferably one to three, more preferably one or two and most preferably exactly one monomer(s) selected from the group consisting of

(Da) vinyl esters,

(db) vinyl ethers,

(Dc) (meth)acrylic esters of alcohols having at least 5 carbon atoms,

(Dd) allyl alcohols or ethers thereof,

(De) N-vinyl compounds selected from the group consisting of vinyl compounds of heterocycles containing at least one nitrogen atom, N-vinylamides or N-vinyllactams,

(Df) ethylenically unsaturated aromatics and

(Dg) α,β-ethylenically unsaturated nitriles,

(Dh) (meth)acrylamides and

(Di) allylamines.

Examples of vinyl esters (Da) are vinyl esters of C₂- to C₁₂-carboxylic acids, preferably vinyl acetate, vinyl propionate, vinyl butyrate, vinyl pentanoate, vinyl hexanoate, vinyl octanoate, vinyl 2-ethylhexanoate, vinyl decanoate, and vinyl esters of Versatic Acids 5 to 10, preferably vinyl esters of 2,2-dimethylpropionic acid (pivalic acid, Versatic Acid 5), 2,2-dimethylbutyric acid (neohexanoic acid, Versatic Acid 6), 2,2-dimethylpentanoic acid (neoheptanoic acid, Versatic Acid 7), 2,2-dimethylhexanoic acid (neooctanoic acid, Versatic Acid 8), 2,2-dimethylheptanoic acid (neononanoic acid, Versatic Acid 9) or 2,2-dimethyloctanoic acid (neodecanoic acid, Versatic Acid 10).

Examples of vinyl ethers (db) are vinyl ethers of C₁- to C₁₂-alkanols, preferably vinyl ethers of methanol, ethanol, iso-propanol, n-propanol, n-butanol, iso-butanol, sec-butanol, tert-butanol, nhexanol, n-heptanol, n-octanol, n-decanol, n-dodecanol (lauryl alcohol) or 2-ethylhexanol.

Preferred (meth)acrylic esters (Dc) are (meth)acrylic esters of C₅- to C₁₂-alkanols, preferably of n-pentanol, n-hexanol, n-heptanol, n-octanol, n-decanol, n-dodecanol (lauryl alcohol), 2-ethylhexanol or 2-propylheptanol. Particular preference is given to pentyl acrylate, 2-ethylhexyl acrylate, 2-propylheptyl acrylate.

Examples of monomers (Dd) are allyl alcohols and allyl ethers of C₂- to C₁₂-alkanols, preferably allyl ethers of methanol, ethanol, iso-propanol, n-propanol, n-butanol, iso-butanol, sec-butanol, tert-butanol, n-hexanol, n-heptanol, n-octanol, n-decanol, n-dodecanol (lauryl alcohol) or 2-ethylhexanol.

Examples of vinyl compounds (De) of heterocycles comprising at least one nitrogen atom are Nvinylpyridine, N-vinylimidazole and N-vinylmorpholine.

Preferred compounds (De) are N-vinylamides or N-vinyllactams.

Examples of N-vinylamides or N-vinyllactams (De) are N-vinylformamide, N-vinylacetamide, Nvinylpyrrolidone and N-vinylcaprolactam.

Examples of ethylenically unsaturated aromatics (Df) are styrene and α-methylstyrene.

Examples of α,β-ethylenically unsaturated nitriles (Dg) are acrylonitrile and methacrylonitrile.

Examples of (meth)acrylamides (Dh) are acrylamide and methacrylamide.

Examples of allylamines (Di) are allylamine, dialkylallylamine and trialkylallylammonium halides.

Preferred monomers (D) are (Da), (db), (Dc), (De) and/or (Df), more preferably (Da), (db) and/or (Dc), even more preferably (Da) and/or (Dc) and especially (Dc).

The incorporation ratio of the monomers (A) and (B) and optionally (C) and optionally (D) in the polymer obtained from reaction step (I) is generally as follows: The molar ratio of (A)/((B) and (C)) (in total) is generally from 10:1 to 1:10, preferably 8:1 to 1:8, more preferably 5:1 to 1:5, even more preferably 3:1 to 1:3, particularly 2:1 to 1:2 and especially 1.5:1 to 1:1.5. In the particular case of maleic anhydride as monomer (A), the molar incorporation ratio of maleic anhydride to monomers ((B) and (C)) (in total) is about 1:1.

The molar ratio of obligatory monomer (B) to monomer (C), if present, is generally of 1:0.05 to 10, preferably of 1:0.1 to 6, more preferably of 1:0.2 to 4, even more preferably of 1:0.3 to 2.5 and especially 1:0.5 to 1.5.

In a preferred embodiment, no optional monomer (C) is present in addition to monomer (B).

The proportion of one or more of the monomers (D), if present, based on the amount of the monomers (A), (B) and optionally (C) (in total) is generally 5 to 200 mol %, preferably 10 to 150 mol %, more preferably 15 to 100 mol %, even more preferably 20 to 50 mol % and especially 0 to 25 mol %.

In a preferred embodiment, no optional monomer (D) is present.

Amino Compound

In a second reaction step (II) the copolymer obtainable, preferably obtained from reaction step (I) is reacted with at least one, preferably one to three, more preferably one or two and most preferably exactly one amino compound of formula (I)

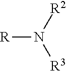

wherein

R is hydrogen (H) or a group —R¹—X—H, wherein

R¹ is a divalent alkylene group comprising 2 to 6 carbon atoms, optionally interrupted by (O) oxygen, NH and/or NR⁴ groups, and/or optionally bearing at least one further substituents, preferably selected from the group consisting of alkyl, alkyloxy, aryl, hydroxy, amino and mono- or dialkylated amino groups,

R² and R³ are independently of another C₁- to C₂₀-alkyl, C₆- to C₁₀-aryl, C₅- to C₁₂-cycloalkyl, or C₇- to C₁₁-aralkyl, wherein R² and R³ together with the nitrogen atom may form a cycloaliphatic or aromatic ring in which further hetero atoms may be incorporated,

X means O (oxygen), NH or NR⁴, preferably O (oxygen) or NH, more preferably NH, and

R⁴ is C₁- to C₄-alkyl or C₆- to C₁₀-aryl, preferably C₁- to C₄-alkyl and very preferably methyl.

Preferred examples of R¹ are 1,2-ethylene, 1,2-propylene, 1,3-propylene, 1,4-butylene, 2-methyl-1,2-propylene, 1,5-pentylene, 1,6-hexylene, 1-phenyl-1,2-propylene, and 2-hydroxy-1,3-propylene. Very preferred examples of R¹ are 1,2-ethylene, 1,2-propylene, 1,3-propylene, and 1,4-butylene, especially preferred examples of R¹ are 1,2-ethylene and 1,3-propylene, wherein 1,3-propylene is most preferred.

R² and R³ are independently of another C₁- to C₂₀-alkyl, C₆- to C₁₀-aryl, C₅- to C₁₂-cycloalkyl, or C₇- to C₁₁-aralkyl, wherein R² and R³ together with the nitrogen atom may form a cycloaliphatic or aromatic ring in which further hetero atoms may be incorporated.

Among the alkyl groups R² and R³ are independently of another are preferably C₁-C₃-alkyl, very preferably C₁-C₄-alkyl, more preferably C₁-C₂-alkyl and especially methyl.

C₁-C₂₀-alkyl is a straight-chain or branched alkyl group having from 1 to 20 carbon atoms. Examples include C₁-C₃-alkyl as mentioned below and also nonyl, decyl, undecyl, dodecyl, tridecyl, tetradecyl, pentadecyl, hexadecyl, heptadecyl, octadecyl, nonadecyl and eicosyl and constitutional isomers thereof.

C₁-C₁₀-alkyl is a straight-chain or branched alkyl group having from 1 to 10 carbon atoms. Examples include C₁-C₃-alkyl as mentioned below and also nonyl, decyl, and constitutional isomers thereof.

C₁-C₃-alkyl is a straight-chain or branched alkyl group having from 1 to 8 carbon atoms. Examples include C₁-C₄ alkyl as mentioned below and also pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, heptyl, octyl, and constitutional isomers thereof, such as 2-ethylhexyl.

C₁-C₄-alkyl is a straight-chain or branched alkyl group having from 1 to 4 carbon atoms. Examples of an alkyl group are methyl, ethyl, n-propyl, iso-propyl, n-butyl, 2-butyl, iso-butyl or tert-butyl. C₁-C₂ alkyl is methyl or ethyl, C₁-C₃ alkyl is additionally n-propyl or isopropyl.

C₆- to C₁₀-aryl denotes a carbocyclic C₆-C₁₀-aromatic radical, preferably phenyl and naphthyl.

Examples for suitable C₅- to C₁₂-cycloalkyl residues are: cyclopentyl, 2-methylcyclopentyl, 3-methylcyclopentyl, 2-methylcyclohexyl, 3-methylcyclohexyl, 4-methylcyclohexyl, 2,3-dimethylcyclohexyl, 2,4-dimethylcyclohexyl, 2,5-dimethylcyclohexyl, 2,6-dimethylcyclohexyl, 3,4-dimethylcyclohexyl, 3,5-dimethylcyclohexyl, 2-ethylcyclohexyl, 3-ethylcyclohexyl, 4-ethylcyclohexyl, cyclooctyl and cyclodecyl.

C₇- to C₁₁-aralkyl are preferably benzyl and phenethyl, very preferably benzyl.

R² and R³ may be the same or different, in a preferred embodiment R² and R³ are the same.

In cases in which R² and R³ together with the nitrogen atom form a ring R² and R³ are preferably 1,4-butylene, 1,5-pentylene, 1,6-hexylene, and 3-oxa-1,5-pentylene.

The ring system which R² and R³ together with the nitrogen atom form may be a pyrrolidine, piperidine, morpholine, piperazine, imidazoline, imidazole or triazole.

Preferably R² and R³ are independently of another C₁- to C₁₀-alkyl, C₆- to C₁₀-aryl or R² and R³ together with the nitrogen atom may form a cycloaliphatic or aromatic ring in which further hetero atoms may be incorporated.

Very preferably R² and R³ are independently of another C₁- to C₄-alkyl or R² and R³ together with the nitrogen atom may form a cycloaliphatic or aromatic ring in which further hetero atoms may be incorporated.

Most preferably R² and R³ are independently of another methyl, ethyl, n-butyl or R² and R³ together are 1,4-butylene, 1,5-pentylene, or 3-oxa-1,5-pentylene.

Especially both R² and R³ are methyl.

Typical examples of compounds of formula (I) are

N,N-dimethyl ethylenediamine, N,N-diethyl ethylenediamine, N,N,N′-trimethyl ethylenediamine, 3-(dimethylamino)propylamine (DMAPA), 3-(diethylamino)propylamine, N-(3-aminopropyl) imidazole, N-(2-amino-ethyl) N′-methyl piperazine, N-(3-amino-propyl) N′-methyl piperazine, N-(3-amino-propyl) piperidine, N-(3-amino-propyl) pyrrolidine, N-(2-amino-ethyl) morpholine, N-(3-amino-propyl) morpholine, N-methyl piperazine, N-ethyl piperazine, and morpholine.

Typical examples of compounds of formula (I) with X═O are

N,N-dimethylethanolamine, N,N-diethylethanolamine, N,N-dimethyl-2-propanolamine, N,N-diethyl-2-propanolamine, 2-hydroxyethyl morpholine, and 2-hydroxyethyl imidazole.

The reaction between the amino group containing component of formula (I) and the copolymer obtainable from reaction step (I) usually takes place at temperatures of from 20° C. to 190° C., preferably 40° C. to 170° C., more preferably 50 to 150° C., in a period of time of fro 5 minutes to 12 hours, preferably of from 10 minutes to 10 hours, more preferably of from 15 minutes to 8 hours, depending on the reaction temperature.

The molar ratio of reactive carboxylic acid equivalent groups to groups —X—H in the amino group containing compound in general is from 1:0.05 to 1:1, preferably 1:0.1 to 1:0.75, more preferably 1:0.2 to 1:0.5 and very preferably 1:0.3 to 1:0.5.

“Equivalent groups” mean carboxylic acid groups reactive with groups —X—H, e.g. 1 in the case of free carboxylic acids or carboxylic acid esters or 2 in the case of an anhydride group.

In a preferred embodiment monomer (A) is an ethylenically unsaturated dicarboxylic acid anhydride, preferably maleic anhydride, and the molar ratio of anhydride groups in copolymer (II) to groups —X—H in the amino compound does not exceed 1:1, preferably is 1:0.1 to 1:1, more preferably 1:0.2 to 1:1, more preferably 1:0.3 to 1:1 and especially 1:0.5 to 1:1.

In a further preferred embodiment monomer (A) is an ethylenically unsaturated dicarboxylic acid anhydride, preferably maleic anhydride, and X is NH. In this embodiment the reaction is conducted under conditions in a manner that at least partially imide groups are formed rather than stopping at the stage of amide groups. Preferably at least 30% of all amide groups formed are converted into imide groups, more preferably at least 50%, even more preferably at least 70%, very preferably at least 80% and especially at least 90%.

The presence of amide- and imide-groups can be proven by infrared spectroscopy.

In order to achieve complete or essentially complete reaction of the reactive group —XH with the corresponding carboxylic acid equivalent group the amine of formula (I) can be dosed into the reaction mixture in a slight excess of at least 1%, preferably at least 2%, more preferably at least 5% and even more preferably at least 10% relative to the amount of —XH groups which are intended to react with the carboxylic acid equivalent group.

Usually an excess of more than 25%, preferably of more than 20%, more preferably of more than 15% does not yield a further positive effect during the reaction.

In another embodiment a mixture of compounds of formula (I) is used in reaction step (II), a part of amino compounds in which X is O (oxygen) and a part of amino compounds in which X is NR⁴ or NH, preferably NH.

The molar ratio between those compounds with X═O and those with X═NH can be from 3:1 to 1:10, preferably 2:1 to 1:8 and more preferably 1:1 to 1:5.

It is an advantage of this embodiment that the products obtained according to this embodiment bear free carboxylic acid groups which additionally to the inventive effect may have a corrosion inhibiting effect.

In a third optional reaction step (III), the anhydride functionalities—if any—present in the copolymer obtained from (II) may be partly or fully hydrolyzed.

Preferably, 10% to 100% of the anhydride functionalities present are hydrolyzed, preferably at least 20%, more preferably at least 30%, even more preferably at least 50% and particularly at least 75% and especially at least 85%.

For a hydrolysis, based on the anhydride functionalities present, the amount of water that corresponds to the desired hydrolysis level is added and the copolymer obtained from (II) is heated in the presence of the added water. In general, a temperature of preferably 20 to 150° C. is sufficient for the purpose, preferably 60 to 100° C. If required, the reaction can be conducted under pressure in order to prevent the escape of water. Under these reaction conditions, in general, the anhydride functionalities in the copolymer are converted selectively, whereas any carboxylic ester functionalities present in the copolymer react at least only to a minor degree, if at all.

The copolymer obtained from reaction step (III) generally has a weight-average molecular weight Mw of 0.5 to 20 kDa, preferably 0.6 to 15, more preferably 0.7 to 7, even more preferably 1 to 7 and especially 1.5 to 4 kDa (determined by gel permeation chromatography with tetrahydrofuran and polystyrene as standard).

The number-average molecular weight Mn is usually from 0.5 to 10 kDa, preferably 0.6 to 5, more preferably 0.7 to 4, even more preferably 0.8 to 3 and especially 1 to 2 kDa (determined by gel permeation chromatography with tetrahydrofuran and polystyrene as standard).

The polydispersity is generally from 1 to 10, preferably from 1.1 to 8, more preferably from 1.2 to 7, even more preferably from 1.3 to 5 and especially from 1.5 to 3.

The content of acid groups in the copolymer is preferably from 0.1 to 10 mmol/g of copolymer, more preferably from 0.2 to 5, even more preferably from 0.3 to 2 mmol/g of copolymer.

The content of amine groups in the copolymer is preferably from 0.1 to 10 mmol/g of copolymer, more preferably from 0.2 to 5, even more preferably from 0.3 to 2 mmol/g of copolymer.

Use

The use of the invention relates to the control of deposits formed by handling and/or combustion of gasoline fuels in direct injection spark ignition engines.

Deposits may be formed in the injection system, preferably in or on the injector more preferably in and on the injector tip, even more preferably in the internal and external injector holes, on the injector seat, the injector outer surface and the injector ball.

“Control” means both reduction or removal of existing deposits as well as inhibition of the formation of new or further deposits.

The copolymers described are added to fuels generally in amounts of 1 to 400 and preferably 4 to 200 ppm by weight, and more preferably from 10 to 50 ppm by weight.

Frequently, the copolymers described are used in the form of fuel additive mixtures, together with customary additives:

In gasoline fuels, these are in particular lubricity improvers (friction modifiers), corrosion inhibitors, demulsifiers, dehazers, antifoams, combustion improvers, antioxidants or stabilizers, antistats, metallocenes, metal deactivators, dyes and/or solvents.

Typical examples of suitable coadditives are listed in the following section:

B1) Detergent additives

The customary detergent additives are preferably amphiphilic substances which possess at least one hydrophobic hydrocarbon radical with a number-average molecular weight (Mn) of 85 to 20 000 and at least one polar moiety selected from:

(B1a) mono- or polyamino groups having up to 6 nitrogen atoms, at least one nitrogen atom having basic properties;

(B1b) nitro groups, optionally in combination with hydroxyl groups;

(B1c) hydroxyl groups in combination with mono- or polyamino groups, at least one nitrogen atom having basic properties;

(B1d) carboxyl groups or the alkali metal or alkaline earth metal salts thereof;

(B1e) sulfonic acid groups or the alkali metal or alkaline earth metal salts thereof;

(B1f) polyoxy-C₂- to C₄-alkylene moieties terminated by hydroxyl groups, mono- or polyamino groups, at least one nitrogen atom having basic properties, or by carbamate groups;

(B1g) carboxylic ester groups;

(B1h) moieties derived from succinic anhydride and having hydroxyl and/or amino and/or amido and/or imido groups;

(B1i) moieties obtained by Mannich reaction of substituted phenols with aldehydes and mono- or polyamines;

(B1j) N-quaternary ammonium salts; and/or

(B1k) the reaction product of a hydrocarbyl-substituted acylating agent and a compound comprising at least one primary or secondary amine group.

The hydrophobic hydrocarbon radical in the above detergent additives, which ensures the adequate solubility in the fuel, has a number-average molecular weight (Mₙ) of 85 to 20 000, preferably of 113 to 10 000, more preferably of 300 to 5000, even more preferably of 300 to 3000, even more especially preferably of 500 to 2500 and especially of 700 to 2500, in particular of 800 to 1500. As typical hydrophobic hydrocarbon radicals, especially in conjunction with the polar, especially polypropenyl, polybutenyl and polyisobutenyl radicals with a number-average molecular weight Mₙ of preferably in each case 300 to 5000, more preferably 300 to 3000, even more preferably 500 to 2500, even more especially preferably 700 to 2500 and especially 800 to 1500 into consideration.

Examples of the above groups of detergent additives include the following:

Additives comprising mono- or polyamino groups (B1a) are preferably polyalkenemono- or polyalkenepolyamines based on polypropene or on high-reactivity (i.e. having predominantly terminal double bonds) or conventional (i.e. having predominantly internal double bonds) polybutene or polyisobutene with Mₙ=300 to 5000, more preferably 500 to 2500 and especially 500 to 1500. Such additives based on high-reactivity polyisobutene, which can be prepared from the polyisobutene which may comprise up to 20% by weight of n-butene units by hydroformylation and reductive amination with ammonia, monoamines or polyamines such as dimethylaminopropylamine, ethylenediamine, diethylenetriamine, triethylenetetramine or tetraethylenepentamine, are known especially from EP-A 244 616. When polybutene or polyisobutene having predominantly internal double bonds (usually in the β and γ positions) are used as starting materials in the preparation of the additives, a possible preparative route is by chlorination and subsequent amination or by oxidation of the double bond with air or ozone to give the carbonyl or carboxyl compound and subsequent amination under reductive (hydrogenating) conditions. The amines used here for the amination may be, for example, ammonia, monoamines or the abovementioned polyamines. Corresponding additives based on polypropene are described more particularly in WO-A 94/24231.

Further particular additives comprising monoamino groups (B1a) are the hydrogenation products of the reaction products of polyisobutenes having an average degree of polymerization P=5 to 100 with nitrogen oxides or mixtures of nitrogen oxides and oxygen, as described more particularly in WO-A 97/03946.

Further particular additives comprising monoamino groups (B1a) are the compounds obtainable from polyisobutene epoxides by reaction with amines and subsequent dehydration and reduction of the amino alcohols, as described more particularly in DE-A 196 20 262.

Further particular additives comprising monoamino groups (B1a) are low molecular primary amines with a number average molecular weight Mₙ of from 140 to 255.

Additives comprising nitro groups (B1b), optionally in combination with hydroxyl groups, are preferably reaction products of polyisobutenes having an average degree of polymerization P=5 to 100 or 10 to 100 with nitrogen oxides or mixtures of nitrogen oxides and oxygen, as described more particularly in WO-A 96/03367 and in WO-A 96/03479. These reaction products are generally mixtures of pure nitropolyisobutenes (e.g. α,β-dinitropolyisobutene) and mixed hydroxynitropolyisobutenes (e.g. α-nitro-β-hydroxypolyisobutene).

Additives comprising hydroxyl groups in combination with mono- or polyamino groups (B1c) are especially reaction products of polyisobutene epoxides obtainable from polyisobutene having preferably predominantly terminal double bonds and Mₙ=300 to 5000, with ammonia or mono- or polyamines, as described more particularly in EP-A 476 485.

Additives comprising carboxyl groups or their alkali metal or alkaline earth metal salts (B1d) are preferably copolymers of C₂- to C₄₀-olefins with maleic anhydride which have a total molar mass of 500 to 20 000 and wherein some or all of the carboxyl groups have been converted to the alkali metal or alkaline earth metal salts and any remainder of the carboxyl groups has been reacted with alcohols or amines. Such additives are disclosed more particularly by EP-A 307 815. Such additives serve mainly to prevent valve seat wear and can, as described in WO-A 87/01126, advantageously be used in combination with customary fuel detergents such as poly(iso)buteneamines or polyetheramines.

Additives comprising sulfonic acid groups or their alkali metal or alkaline earth metal salts (B1e) are preferably alkali metal or alkaline earth metal salts of an alkyl sulfosuccinate, as described more particularly in EP-A 639 632. Such additives serve mainly to prevent valve seat wear and can be used advantageously in combination with customary fuel detergents such as poly(iso)buteneamines or polyetheramines.

Additives comprising polyoxy-C₂-C₄-alkylene moieties (B1f) are preferably polyethers or polyetheramines which are obtainable by reaction of C₂- to C₆₀-alkanols, C₆- to C₃₀-alkanediols, mono- or di-C₂- to C₃₀-alkylamines, C₁- to C₃₀-alkylcyclohexanols or C₁- to C₃₀-alkylphenols with 1 to 30 mol of ethylene oxide and/or propylene oxide and/or butylene oxide per hydroxyl group or amino group and, in the case of the polyetheramines, by subsequent reductive amination with ammonia, monoamines or polyamines. Such products are described more particularly in EP-A 310 875, EP-A 356 725, EP-A 700 985 and U.S. Pat. No. 4,877,416. In the case of polyethers, such products also have carrier oil properties. Typical examples thereof are tridecanol butoxylates or isotridecanol butoxylates, isononylphenol butoxylates and also polyisobutenol butoxylates and propoxylates, and also the corresponding reaction products with ammonia.

Additives comprising carboxylic ester groups (B1g) are preferably esters of mono-, di- or tricarboxylic acids with long-chain alkanols or polyols, especially those having a minimum viscosity of 2 mm²/s at 100° C., as described more particularly in DE-A 38 38 918. The mono-, di- or tricarboxylic acids used may be aliphatic or aromatic acids, and particularly suitable ester alcohols or ester polyols are long-chain representatives having, for example, 6 to 24 carbon atoms. Typical representatives of the esters are adipates, phthalates, isophthalates, terephthalates and trimellitates of isooctanol, of isononanol, of isodecanol and of isotridecanol. Such products also satisfy carrier oil properties.

Additives comprising moieties derived from succinic anhydride and having hydroxyl and/or amino and/or amido and/or especially imido groups (B1h) are preferably corresponding derivatives of alkyl- or alkenyl-substituted succinic anhydride and especially the corresponding derivatives of polyisobutenylsuccinic anhydride which are obtainable by reacting conventional or high-reactivity polyisobutene having Mₙ=preferably 300 to 5000, more preferably 300 to 3000, even more preferably 500 to 2500, even more especially preferably 700 to 2500 and especially 800 to 1500, with maleic anhydride by a thermal route in an ene reaction or via the chlorinated polyisobutene. The moieties having hydroxyl and/or amino and/or amido and/or imido groups are, for example, carboxylic acid groups, acid amides of monoamines, acid amides of di- or polyamines which, in addition to the amide function, also have free amine groups, succinic acid derivatives having an acid and an amide function, carboximides with monoamines, carboximides with di- or polyamines which, in addition to the imide function, also have free amine groups, or diimides which are formed by the reaction of di- or polyamines with two succinic acid derivatives. Such fuel additives are common knowledge and are described, for example, in documents (1) and (2). They are preferably the reaction products of alkyl- or alkenyl-substituted succinic acids or derivatives thereof with amines and more preferably the reaction products of polyisobutenylsubstituted succinic acids or derivatives thereof with amines. Of particular interest in this context are reaction products with aliphatic polyamines (polyalkyleneimines) such as, more particularly, ethylenediamine, diethylenetriamine, triethylenetetramine, tetraethylenepentamine, pentaethylenehexamine and hexaethyleneheptamine, which have an imide structure.

Additives comprising moieties (B1i) obtained by Mannich reaction of substituted phenols with aldehydes and mono- or polyamines are preferably reaction products of polyisobutenesubstituted phenols, preferably hydrocarbyl-substituted phenols or cresols, very preferably polyisobutyl-substituted phenols or cresols, with formaldehyde and mono- or polyamines such as dimethylamine, diethylamine, ethylenediamine, diethylenetriamine, triethylenetetramine, tetraethylenepentamine or dimethylaminopropylamine. The polyisobutenyl-substituted phenols may originate from conventional or high-reactivity polyisobutene having Mₙ=300 to 5000. Such “polyisobutene Mannich bases” are described more particularly in EP-A 831 141.

Additives comprising N-quaternary ammonium salts (B1j) are reaction products of tertiary amines with quaternizing agents. Typical quaternizing agents are alkyleneoxides, dialkyl sulfates, dialkyl carbonates, alkyl esters of mono or dicarboxylic acids, such as dialkyl oxalates, dialkyl phthatales or alkyl salicylates, or chloro acetic acid esters. Preferably the alkyl groups transferred in the quaternization are methyl or ethyl groups, more preferably methyl groups.

Preferred examples of N-quaternary ammonium salts are described in WO 14/195464, WO 13/087701, WO 13/000997, WO 12/004300. Furthermore, it is conceivable to use quaternized Mannich products, as described in WO 08/027881 or EP 2796446.

Additives (B1k) are reaction products of a hydrocarbyl-substituted acylating agent and a compound comprising at least one primary or secondary amine group. Typical examples are nonquaternized compounds (B1j) or described in GB 2487619 B2.

One or more of the detergent additives mentioned can be added to the fuel in such an amount that the dosage rate of these detergent additives is preferably 25 to 2500 ppm by weight, especially 75 to 1500 ppm by weight, in particular 150 to 1000 ppm by weight.

B2) Carrier Oils

Carrier oils additionally used may be of mineral or synthetic nature. Suitable mineral carrier oils are fractions obtained in crude oil processing, such as brightstock or base oils having viscosities, for example, from the SN 500-2000 class; but also aromatic hydrocarbons, paraffinic hydrocarbons and alkoxyalkanols. Likewise useful is a fraction which is obtained in the refining of mineral oil and is known as “hydrocrack oil” (vacuum distillate cut having a boiling range of from about 360 to 500° C., obtainable from natural mineral oil which has been catalytically hydrogenated under high pressure and isomerized and also deparaffinized). Likewise suitable are mixtures of the abovementioned mineral carrier oils.

Examples of suitable synthetic carrier oils are polyolefins (polyalphaolefins or polyinternalolefins), (poly)esters, (poly)alkoxylates, polyethers, aliphatic polyether-amines, alkylphenol-started polyethers, alkylphenol-started polyetheramines and carboxylic esters of long-chain alkanols.

Examples of suitable polyolefins are olefin polymers having Mₙ=400 to 1800, in particular based on polybutene or polyisobutene (hydrogenated or unhydrogenated).

Examples of suitable polyethers or polyetheramines are preferably compounds comprising polyoxy-C₂- to C₄-alkylene moieties obtainable by reacting C₂- to C₆₀-alkanols, C₆- to C₃₀ alkanediols, mono- or di-C₂- to C₃₀-alkylamines, C₁- to C₃₀-alkylcyclohexanols or C₁- to C₃₀alkylphenols with 1 to 30 mol of ethylene oxide and/or propylene oxide and/or butylene oxide per hydroxyl group or amino group, and, in the case of the polyetheramines, by subsequent reductive amination with ammonia, monoamines or polyamines. Such products are described more particularly in EP-A 310 875, EP-A 356 725, EP-A 700 985 and U.S. Pat. No. 4,877,416. For example, the polyetheramines used may be poly-C₂- to C₆-alkylene oxide amines or functional derivatives thereof. Typical examples thereof are tridecanol butoxylates or isotridecanol butoxylates, isononylphenol butoxylates and also polyisobutenol butoxylates and propoxylates, and also the corresponding reaction products with ammonia.

Examples of carboxylic esters of long-chain alkanols are more particularly esters of mono-, di- or tricarboxylic acids with long-chain alkanols or polyols, as described more particularly in DE-A 38 38 918. The mono-, di- or tricarboxylic acids used may be aliphatic or aromatic acids; particularly suitable ester alcohols or ester polyols are long-chain representatives having, for example, 6 to 24 carbon atoms. Typical representatives of the esters are adipates, phthalates, isophthalates, terephthalates and trimellitates of isooctanol, isononanol, isodecanol and isotridecanol, for example di(n- or isotridecyl) phthalate.

Further suitable carrier oil systems are described, for example, in DE-A 38 26 608, DE-A 41 42 241, DE-A 43 09 074, EP-A 452 328 and EP-A 548 617.

Examples of particularly suitable synthetic carrier oils are alcohol-started polyethers having about 5 to 35, preferably about 5 to 30, more preferably 10 to 30 and especially 15 to 30 C₃- to C₆-alkylene oxide units, for example propylene oxide, n-butylene oxide and isobutylene oxide units, or mixtures thereof, per alcohol molecule. Nonlimiting examples of suitable starter alcohols are long-chain alkanols or phenols substituted by long-chain alkyl in which the long-chain alkyl radical is especially a straight-chain or branched C₆- to C₁₈-alkyl radical. Particular examples include tridecanol and nonylphenol. Particularly preferred alcohol-started polyethers are the reaction products (polyetherification products) of monohydric aliphatic C₆- to C₁₃-alcohols with C₃- to C₆-alkylene oxides. Examples of monohydric aliphatic C₆-C₁₃-alcohols are hexanol, heptanol, octanol, 2-ethylhexanol, nonyl alcohol, decanol, 3-propylheptanol, undecanol, dodecanol, tridecanol, tetradecanol, pentadecanol, hexadecanol, octadecanol and the constitutional and positional isomers thereof. The alcohols can be used either in the form of the pure isomers or in the form of technical grade mixtures. A particularly preferred alcohol is tridecanol. Examples of C₃- to C₆-alkylene oxides are propylene oxide, such as 1,2-propylene oxide, butylene oxide, such as 1,2-butylene oxide, 2,3-butylene oxide, isobutylene oxide or tetrahydrofuran, pentylene oxide and hexylene oxide. Particular preference among these is given to C₃- to C₄-alkylene oxides, i.e. propylene oxide such as 1,2-propylene oxide and butylene oxide such as 1,2-butylene oxide, 2,3-butylene oxide and isobutylene oxide. Especially butylene oxide is used.

Further suitable synthetic carrier oils are alkoxylated alkylphenols, as described in DE-A 10 102 913.

Particular carrier oils are synthetic carrier oils, particular preference being given to the abovedescribed alcohol-started polyethers.

The carrier oil or the mixture of different carrier oils is added to the fuel in an amount of preferably 1 to 1000 ppm by weight, more preferably of 10 to 500 ppm by weight and especially of 20 to 100 ppm by weight.

B3) Cold Flow Improvers

Suitable cold flow improvers are in principle all organic compounds which are capable of improving the flow performance of fuels under cold conditions. For the intended purpose, they must have sufficient oil solubility. More particularly, useful cold flow improvers for this purpose are the cold flow improvers (middle distillate flow improvers, MDFIs) typically used. However, it is also possible to use organic compounds which partly or predominantly have the properties of a wax antisettling additive (WASA) when used in fuels. They can also act partly or predominantly as nucleators. It is also possible to use mixtures of organic compounds effective as MDFIs and/or effective as WASAs and/or effective as nucleators.

The cold flow improver is typically selected from:

(K1) copolymers of a C₂- to C₄₀-olefin with at least one further ethylenically unsaturated monomer;

(K2) comb polymers;

(K3) polyoxyalkylenes;

(K4) polar nitrogen compounds;

(K5) sulfocarboxylic acids or sulfonic acids or derivatives thereof; and

(K6) poly(meth)acrylic esters.

It is possible to use either mixtures of different representatives from one of the particular classes (K1) to (K6) or mixtures of representatives from different classes (K1) to (K6).

Suitable C₂- to C₄₀-olefin monomers for the copolymers of class (K1) are, for example, those having 2 to 20 and especially 2 to 10 carbon atoms, and 1 to 3 and preferably 1 or 2 carbon-carbon double bonds, especially having one carbon-carbon double bond. In the latter case, the carbon-carbon double bond may be arranged either terminally (α-olefins) or internally. However, preference is given to α-olefins, particular preference to α-olefins having 2 to 6 carbon atoms, for example propene, 1-butene, 1-pentene, 1-hexene and in particular ethylene.

In the copolymers of class (K1), the at least one further ethylenically unsaturated monomer is preferably selected from alkenyl carboxylates, (meth)acrylic esters and further olefins.

When further olefins are also copolymerized, they are preferably higher in molecular weight than the abovementioned C₂- to C₄₀-olefin base monomers. When, for example, the olefin base monomer used is ethylene or propene, suitable further olefins are especially C₁₀- to C₄₀-α-olefins. Further olefins are in most cases only additionally copolymerized when monomers with carboxylic ester functions are also used.

Suitable (meth)acrylic esters are, for example, esters of (meth)acrylic acid with C₁- to C₂₀ alkanols, especially C₁- to C₁₀-alkanols, in particular with methanol, ethanol, propanol, isopropanol, n-butanol, sec-butanol, isobutanol, tert-butanol, pentanol, hexanol, heptanol, octanol, 2-ethylhexanol, nonanol and decanol, and structural isomers thereof.

Suitable alkenyl carboxylates are, for example, C₂- to C₁₄-alkenyl esters, for example the vinyl and propenyl esters, of carboxylic acids having 2 to 21 carbon atoms, whose hydrocarbyl radical may be linear or branched. Among these, preference is given to the vinyl esters. Among the carboxylic acids with a branched hydrocarbyl radical, preference is given to those whose branch is in the α position to the carboxyl group, and the α-carbon atom is more preferably tertiary, i.e. the carboxylic acid is what is called a neocarboxylic acid. However, the hydrocarbyl radical of the carboxylic acid is preferably linear.

Examples of suitable alkenyl carboxylates are vinyl acetate, vinyl propionate, vinyl butyrate, vinyl 2-ethylhexanoate, vinyl neopentanoate, vinyl hexanoate, vinyl neononanoate, vinyl neodecanoate and the corresponding propenyl esters, preference being given to the vinyl esters. A particularly preferred alkenyl carboxylate is vinyl acetate; typical copolymers of group (K1) resulting therefrom are ethylene-vinyl acetate copolymers (“EVAs”), which are some of the most frequently used.

Ethylene-vinyl acetate copolymers usable particularly advantageously and the preparation thereof are described in WO 99/29748.

Suitable copolymers of class (K1) are also those which comprise two or more different alkenyl carboxylates in copolymerized form, which differ in the alkenyl function and/or in the carboxylic acid group. Likewise suitable are copolymers which, as well as the alkenyl carboxylate(s), comprise at least one olefin and/or at least one (meth)acrylic ester in copolymerized form.

Terpolymers of a C₂- to C₄₀-α-olefin, a C₁- to C₂₀-alkyl ester of an ethylenically unsaturated monocarboxylic acid having 3 to 15 carbon atoms and a C₂- to C₁₄-alkenyl ester of a saturated monocarboxylic acid having 2 to 21 carbon atoms are also suitable as copolymers of class (K1). Terpolymers of this kind are described in WO 2005/054314. A typical terpolymer of this kind is formed from ethylene, 2-ethylhexyl acrylate and vinyl acetate.

The at least one or the further ethylenically unsaturated monomer(s) are copolymerized in the copolymers of class (K1) in an amount of preferably 1 to 50% by weight, especially 10 to 45% by weight and in particular 20 to 40% by weight, based on the overall copolymer. The main proportion in terms of weight of the monomer units in the copolymers of class (K1) therefore originates generally from the C₂- to C₄₀ base olefins.

The copolymers of class (K1) preferably have a number-average molecular weight Mₙ of 1000 to 20 000, more preferably of 1000 to 10 000 and especially of 1000 to 8000.

Typical comb polymers of component (K2) are, for example, obtainable by the copolymerization of maleic anhydride or fumaric acid with another ethylenically unsaturated monomer, for example with an α-olefin or an unsaturated ester, such as vinyl acetate, and subsequent esterification of the anhydride or acid function with an alcohol having at least 10 carbon atoms. Further suitable comb polymers are copolymers of α-olefins and esterified comonomers, for example esterified copolymers of styrene and maleic anhydride or esterified copolymers of styrene and fumaric acid. Suitable comb polymers may also be polyfumarates or polymaleates. Homo- and copolymers of vinyl ethers are also suitable comb polymers. Comb polymers suitable as components of class (K2) are, for example, also those described in WO 2004/035715 and in “Comb-Like Polymers, Structure and Properties”, N. A. Platé and V. P. Shibaev, J. Poly. Sci. Macromolecular Revs. 8, pages 117 to 253 (1974). Mixtures of comb polymers are also suitable.

Polyoxyalkylenes suitable as components of class (K3) are, for example, polyoxyalkylene esters, polyoxyalkylene ethers, mixed polyoxyalkylene ester/ethers and mixtures thereof. These polyoxyalkylene compounds preferably comprise at least one linear alkyl group, preferably at least two linear alkyl groups, each having 10 to 30 carbon atoms and a polyoxyalkylene group having a number-average molecular weight of up to 5000. Such polyoxyalkylene compounds are described, for example, in EP-A 061 895 and also in U.S. Pat. No. 4,491,455. Particular polyoxyalkylene compounds are based on polyethylene glycols and polypropylene glycols having a number-average molecular weight of 100 to 5000. Additionally suitable are polyoxyalkylene mono- and diesters of fatty acids having 10 to 30 carbon atoms, such as stearic acid or behenic acid.

Polar nitrogen compounds suitable as components of class (K4) may be either ionic or nonionic and preferably have at least one substituent, especially at least two substituents, in the form of a tertiary nitrogen atom of the general formula >NR⁷ in which R⁷ is a C₈- to C₄₀-hydrocarbyl radical. The nitrogen substituents may also be quaternized, i.e. be in cationic form. Examples of such nitrogen compounds are ammonium salts and/or amides which are obtainable by the reaction of at least one amine substituted by at least one hydrocarbyl radical with a carboxylic acid having 1 to 4 carboxyl groups or with a suitable derivative thereof. The amines preferably comprise at least one linear C₈- to C₄₀-alkyl radical. Primary amines suitable for preparing the polar nitrogen compounds mentioned are, for example, octylamine, nonylamine, decylamine, undecylamine, dodecylamine, tetradecylamine and the higher linear homologs; secondary amines suitable for this purpose are, for example, dioctadecylamine and methylbehenylamine. Also suitable for this purpose are amine mixtures, especially amine mixtures obtainable on the industrial scale, such as fatty amines or hydrogenated tallamines, as described, for example, in Ullmann's Encyclopedia of Industrial Chemistry, 6th Edition, “Amines, aliphatic” chapter. Acids suitable for the reaction are, for example, cyclohexane-1,2-dicarboxylic acid, cyclohexene-1,2-dicarboxylic acid, cyclopentane-1,2-dicarboxylic acid, naphthalenedicarboxylic acid, phthalic acid, isophthalic acid, terephthalic acid, and succinic acids substituted by long-chain hydrocarbyl radicals.

More particularly, the component of class (K4) is an oil-soluble reaction product of poly(C₂- to C₂₀-carboxylic acids) having at least one tertiary amino group with primary or secondary amines. The poly(C₂- to C₂₀-carboxylic acids) which have at least one tertiary amino group and form the basis of this reaction product comprise preferably at least 3 carboxyl groups, especially 3 to 12 and in particular 3 to 5 carboxyl groups. The carboxylic acid units in the polycarboxylic acids have preferably 2 to 10 carbon atoms, and are especially acetic acid units. The carboxylic acid units are suitably bonded to the polycarboxylic acids, usually via one or more carbon and/or nitrogen atoms. They are preferably attached to tertiary nitrogen atoms which, in the case of a plurality of nitrogen atoms, are bonded via hydrocarbon chains.

The component of class (K4) is preferably an oil-soluble reaction product based on poly(C₂- to C₂₀-carboxylic acids) which have at least one tertiary amino group and are of the general formula Ia IIa or IIb

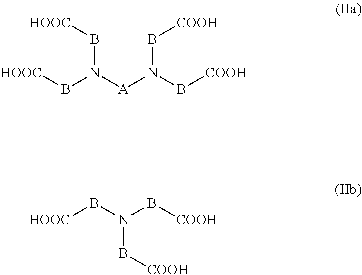

in which the variable A is a straight-chain or branched C₂- to C₆-alkylene group or the moiety of the formula III

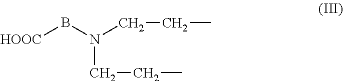

and the variable B is a C₁- to C₁₉-alkylene group. The compounds of the general formulae IIa and IIb especially have the properties of a WASA.

Moreover, the preferred oil-soluble reaction product of component (K4), especially that of the general formula IIa or IIb, is an amide, an amide-ammonium salt or an ammonium salt in which no, one or more carboxylic acid groups have been converted to amide groups.

Straight-chain or branched C₂- to C₆-alkylene groups of the variable A are, for example, 1,1-ethylene, 1,2-propylene, 1,3-propylene, 1,2-butylene, 1,3-butylene, 1,4-butylene, 2-methyl-1,3-propylene, 1,5-pentylene, 2-methyl-1,4-butylene, 2,2-dimethyl-1,3-propylene, 1,6-hexylene (hexamethylene) and especially 1,2-ethylene. The variable A comprises preferably 2 to 4 and especially 2 or 3 carbon atoms.

C₁- to C₁₉-alkylene groups of the variable B are, for example, 1,2-ethylene, 1,3-propylene, 1,4-butylene, hexamethylene, octamethylene, decamethylene, dodecamethylene, tetradecamethylene, hexadecamethylene, octadecamethylene, nonadecamethylene and especially methylene. The variable B comprises preferably 1 to 10 and especially 1 to 4 carbon atoms.

The primary and secondary amines as a reaction partner for the polycarboxylic acids to form component (K4) are typically monoamines, especially aliphatic monoamines. These primary and secondary amines may be selected from a multitude of amines which bear hydrocarbyl radicals which may optionally be bonded to one another.

These parent amines of the oil-soluble reaction products of component (K4) are usually secondary amines and have the general formula HN(R⁸)₂ in which the two variables R⁸ are each independently straight-chain or branched C₁₀- to C₃₀-alkyl radicals, especially C₁₄- to C₂₄-alkyl radicals. These relatively long-chain alkyl radicals are preferably straight-chain or only slightly branched. In general, the secondary amines mentioned, with regard to their relatively long-chain alkyl radicals, derive from naturally occurring fatty acids and from derivatives thereof. The two R⁸ radicals are preferably identical.

The secondary amines mentioned may be bonded to the polycarboxylic acids by means of amide structures or in the form of the ammonium salts; it is also possible for only a portion to be present as amide structures and another portion as ammonium salts. Preferably only few, if any, free acid groups are present. The oil-soluble reaction products of component (K4) are preferably present completely in the form of the amide structures.

Typical examples of such components (K4) are reaction products of nitrilotriacetic acid, of ethylenediaminetetraacetic acid or of propylene-1,2-diaminetetraacetic acid with in each case 0.5 to 1.5 mol per carboxyl group, especially 0.8 to 1.2 mol per carboxyl group, of dioleylamine, dipalmitamine, dicocoamine, distearylamine, dibehenylamine or especially ditallamine. A particularly preferred component (K4) is the reaction product of 1 mol of ethylenediaminetetraacetic acid and 4 mol of hydrogenated ditallamine.

Further typical examples of component (K4) include the N,N-dialkylammonium salts of 2-N′,N′dialkylamidobenzoates, for example the reaction product of 1 mol of phthalic anhydride and 2 mol of ditallamine, the latter being hydrogenated or unhydrogenated, and the reaction product of 1 mol of an alkenylspirobislactone with 2 mol of a dialkylamine, for example ditallamine and/or tallamine, the latter two being hydrogenated or unhydrogenated.

Further typical structure types for the component of class (K4) are cyclic compounds with tertiary amino groups or condensates of long-chain primary or secondary amines with carboxylic acid-containing polymers, as described in WO 93/18115.

Sulfocarboxylic acids, sulfonic acids or derivatives thereof which are suitable as cold flow improvers of the component of class (K5) are, for example, the oil-soluble carboxamides and carboxylic esters of ortho-sulfobenzoic acid, in which the sulfonic acid function is present as a sulfonate with alkyl-substituted ammonium cations, as described in EP-A 261 957.

Poly(meth)acrylic esters suitable as cold flow improvers of the component of class (K6) are either homo- or copolymers of acrylic and methacrylic esters. Preference is given to copolymers of at least two different (meth)acrylic esters which differ with regard to the esterified alcohol. The copolymer optionally comprises another different olefinically unsaturated monomer in copolymerized form. The weight-average molecular weight of the polymer is preferably 50 000 to 500 000. A particularly preferred polymer is a copolymer of methacrylic acid and methacrylic esters of saturated C₁₄- and C₁₅-alcohols, the acid groups having been neutralized with hydrogenated tallamine. Suitable poly(meth)acrylic esters are described, for example, in WO 00/44857.

The cold flow improver or the mixture of different cold flow improvers is added to the fuel in a total amount of preferably 10 to 5000 ppm by weight, more preferably of 20 to 2000 ppm by weight, even more preferably of 50 to 1000 ppm by weight and especially of 100 to 700 ppm by weight, for example of 200 to 500 ppm by weight.

B4) Lubricity Improvers

Suitable lubricity improvers or friction modifiers are based typically on fatty acids or fatty acid esters. Typical examples are tall oil fatty acid, as described, for example, in WO 98/004656, and glyceryl monooleate. The reaction products, described in U.S. Pat. No. 6,743,266 B2, of natural or synthetic oils, for example triglycerides, and alkanolamines are also suitable as such lubricity improvers.

B5) Corrosion Inhibitors

Suitable corrosion inhibitors are, for example, succinic esters, in particular with polyols, fatty acid derivatives, for example oleic esters, oligomerized fatty acids, substituted ethanolamines, and products sold under the trade name RC 4801 (Rhein Chemie Mannheim, Germany), Irgacor® L12 (BASF SE) or HiTEC 536 (Ethyl Corporation).

In a preferred embodiment corrosion inhibitors are those described in WO 15/113681.

B6) Demulsifiers

Suitable demulsifiers are, for example, the alkali metal or alkaline earth metal salts of alkylsubstituted phenol- and naphthalenesulfonates and the alkali metal or alkaline earth metal salts of fatty acids, and also neutral compounds such as alcohol alkoxylates, e.g. alcohol ethoxylates, phenol alkoxylates, e.g. tert-butylphenol ethoxylate or tert-pentylphenol ethoxylate, fatty acids, alkylphenols, condensation products of ethylene oxide (EO) and propylene oxide (PO), for example including in the form of EO/PO block copolymers, polyethyleneimines or else polysiloxanes.

B7) Dehazers

Suitable dehazers are, for example, alkoxylated phenol-formaldehyde condensates, for example the products available under the trade names NALCO 7D07 (Nalco) and TOLAD 2683 (Petrolite).

B8) Antifoams

Suitable antifoams are, for example, polyether-modified polysiloxanes, for example the products available under the trade names TEGOPREN 5851 (Goldschmidt), Q 25907 (Dow Corning) and RHODOSIL (Rhone Poulenc).

B9) Octane number improvers are for example tetraethyllead, tetramethyllead, methylcyclopentadienyl-manganese-tricarbonyl, ferrocene, methyl-tert-butylether, ethyl-tert-butylether, ethanol, N-methylaniline, isomers of methylaniline.

B10) Antioxidants

Suitable antioxidants are, for example substituted phenols, such as 2,6-di-tert-butylphenol and 6-di-tert-butyl-3-methylphenol, and also phenylenediamines such as N,N′-di-sec-butyl-pphenylenediamine.

B11) Metal deactivators

Suitable metal deactivators are, for example, salicylic acid derivatives such as N,N′-disalicylidene-1,2-propanediamine.

B12) Solvents

Suitable solvents are, for example, nonpolar organic solvents such as aromatic and aliphatic hydrocarbons, for example toluene, xylenes, white spirit and products sold under the trade names SHELLSOL (Royal Dutch/Shell Group) and EXXSOL (ExxonMobil), and also polar organic solvents, for example, alcohols such as 2-ethylhexanol, decanol and isotridecanol. Such solvents are usually added to the fuel together with the aforementioned additives and coadditives, which they are intended to dissolve or dilute for better handling.

C) Fuels

The inventive use relates to gasoline fuels.

The term “gasoline” includes blends of distillate hydrocarbon fuels with oxygenated compounds such as tert. butyl methyl ether, tert. butyl ethyl ether, methanol or ethanol, or isopropanol, or isobutanol, or tert-butanol, or ether with 5 or more carbon atoms or other oxygen-containing compounds with a boiling point of below 210° C., preferably ethanol, as well as the distillate fuels themselves. Furthermore, the term “gasoline” includes oxygenated compounds being essentially free of hydrocarbons, preferably methanol or ethanol or mixtures thereof.

Suitable gasolines are e.g. those described in Dabelstein, W., Reglitzky, A., Schütze, A., Reders, K. and Brunner, A. (2016). Automotive Fuels. In Ullmann's Encyclopedia of Industrial Chemistry, (Ed.). doi:10.1002/14356007.a16_719

In addition to the mineral middle distillate fuels obtainable by refining, those obtainable by coal gasification or gas liquefaction [“gas to liquid” (GTL) fuels] or by biomass liquefaction [“biomass to liquid” (BTL) fuels] are also suitable. Also suitable are mixtures of the aforementioned fuels with renewable fuels, such as bioethanol.

Suitable gasolines are e.g. those having an aromatics content of not more than 60% by volume, e.g. not more than 42% by volume or not more than 35% by volume and/or a sulfur content of not more than 2000 ppm by weight, e.g. not more than 150 ppm by weight or not more than 10 ppm by weight.

In a preferred embodiment, the aromatics content of the gasoline is e.g. from 10 to 50% by volume, e.g. from 30 to 42% by volume, in particular from 32 to 40% by volume or not more than 35% by volume.

In another preferred embodiment, the sulfur content is e.g. of from 2 to 500 ppm by weight, e.g. of from 5 to 100 or not more than 10 ppm by weight.

In another preferred embodiment, the olefin content of the gasoline can be up to 50% by volume, e.g. from 6 to 21% by volume, in particular from 7 to 18% by volume.

In another preferred embodiment, the gasoline has a benzene content of not more than 5% by volume, e.g. from 0.5 to 1.0% by volume, in particular from 0.6 to 0.9% by volume.

In another preferred embodiment, the gasoline has an oxygen content of not more than 30% by weight, e.g. up to 10% by weight or from 1.0 to 3.7% by weight, and in particular from 1.2 to 2.7% by weight.

Particular preference is given to a gasoline which has an aromatics content of not more than 38% by volume or preferably not more than 35% by volume, and at the same time an olefin content of not more than 21% by volume, a sulfur content of not more than 50 or 10 ppm by weight, a benzene content of not more than 1.0% by volume and an oxygen content of from 1.0 to 2.7% by weight.

The amount of alcohols and ethers contained in the gasoline may vary over wide ranges. Typical maximum contents are e.g. methanol 15% by volume, ethanol 85% by volume, isopropanol 20% by volume, tert-butanol 15% by volume, isobutanol 20% by volume and ethers containing 5 or more carbon atoms in the molecule 30% by volume.

The summer vapor pressure of the gasoline (at 37° C.) is usually not more than 70 kPa, in particular not more than 60 kPa.

The research octane number (RON) of the gasoline is usually from 75 to 105. A usual range for the corresponding motor octane number (MON) is from 65 to 95.

The above characteristics are determined by conventional methods (DIN EN 228).

Suitable gasolines comply to DIN EN 228:2017-08.

Moreover, the invention is related to an additive concentrate, comprising at least one copolymer as defined above and at least one diluent and at least one further additive. Suitable additional additives are those mentioned above.

It has surprisingly been found that the use of the copolymers according to the invention in liquid fuel compositions can also provide benefits in terms of improved fuel economy of an internal combustion engine being fueled by the liquid fuel composition of the present invention, relative to the internal combustion engine being fueled by the liquid base fuel.

The present invention therefore provides a method of improving the fuel economy performance of a liquid base fuel suitable for use in an internal combustion engine, comprising admixing one or more copolymers according to the invention with a major portion of the liquid base fuel suitable for use in an internal combustion engine.

It has further been observed that the use of the copolymers according to the invention in liquid fuel compositions can also provide benefits in terms of engine cleanliness, in particular in terms of improved inlet valve deposit keep clean and/or injector nozzle keep clean performance, of an internal combustion engine being fueled by the liquid fuel composition of the present invention relative to the internal combustion engine being fueled by the liquid base fuel.

Engine cleanliness can be further enhanced by the use of a copolymer according to the invention in combination with a detergent fuel additive. The combined use in a fuel composition of the present invention appears to act synergistically to provide a greater enhanced engine cleanliness than would be achieved by the use of either component alone. It has further been observed that use of a copolymer according to the invention in the fuel composition of the present invention appears to lead to diffused fuel residues and thereby reducing the likelihood that fuel deposits will form in use for example on engine valves.

This diffusion of residue deposits is observed whether the copolymer according to the invention is used alone in the composition or in combination with a detergent fuel additive.

When used in combination with a detergent fuel additive, the amount of copolymer according to the invention in the fuel composition is suitably in the range of from 5 ppmw to 500 ppmw, most suitably from 20 ppmw to 300 ppmw, for example 40 to 200 ppmw, based on total fuel composition.

The amount of a detergent fuel additive is suitably in the range of from 20 ppmw to 500 ppmw, suitably 50 to 300 ppmw, based on the total fuel composition.

By the term “improved/improving inlet valve deposit keep clean performance”, it is meant that the weight of deposit formed on the inlet valve of the engine is reduced relative to the base fuel not containing one or more copolymers according to the invention.

By the term “improved/improving injector nozzle keep clean performance”, it is meant that the amount of deposit formed on the injector nozzle of the engine is reduced as measured by the loss of engine torque.

In contrast to other dispersants, the copolymers according to the invention used in the present invention have furthermore been found to be fully soluble in alcohol-based fuel compositions, especially E100, E85 and E10 compositions, and impart no colour or haze to the final formulation.

The present invention further provides a method of operating an internal combustion engine, which method involves introducing into a combustion chamber of the engine a liquid fuel composition according to the present invention.

The present invention will be further understood from the following examples which are intended to illustrate the present invention, without restricting it. Unless otherwise stated, all amounts and concentrations disclosed in the examples are based on weight of the fully formulated fuel composition.

It has surprisingly been found that the use of the copolymers according to the invention as additives for gasoline fuel can decrease engine emissions of particulate matter, unburnt hydrocarbons, carbon monoxide CO, nitrogen oxides NOₓ, and carbon dioxide CO₂.

### EXAMPLES

Methods and Reagents:

3-(Dimethylamino)propylamine (DMAPA), CAS 109-55-7

1,3,5-Tris[3-(dimethylamino)propyl]hexahydro-1,3,5-triazine, CAS 15875-13-5

Kerocom® PIBA (65% by weight solution of polyisobutylene amine based on high-reactivity polyisobutene (after hydroformylation and amination), Mₙ=1000, in an aliphatic hydrocarbon mixture), according to DE 10314809 A1.

N,N-Dimethylethanolamine (DMEOA), CAS 108-01-0

All from BASF SE.

Hydrosol® A200 ND from DHC Solvent Chemie GmbH.

Nalco® 5406: Corrosion inhibitor based on dimer fatty acid from Baker Hughes.

Determination of total base nitrogen according to DIN EN 13716:2001.

Solid content was determined using a Mettler Toledo, HB43-S, Halogen moisture analyser. Solvent was evaporated at 140° C. for 30 minutes.

Determination of Mₙ, M_{w} and polydispersity D by gel permeation chromatography (GPC).

Method A: Eluent THF+0.1% trifluoroacetic acid, column temperature 35° C., flow velocity 1 mL/min, sample concentration 2 mg/mL in eluent, sample injection volume 100 μL, sample solutions were filtrated over Chromafil Xtra PTFE (0.20 μm) prior to injection, guard column Plgel (length 5 cm, diameter 7.5 mm), main column PLgel MIXED-B (length 30 cm, diameter 7.5 mm), detector DRI Agilent 1100 series, calibration was done with polystyrene standards with M=580 to M=6870000 from Polymer Laboratories and hexylbenzene (M=162). Samples were dissolved in the eluent.

Method B: Eluent THF+0.035 mol/I diethanolamine, column temperature 35° C., flow velocity 1 mL/min, sample concentration 2 mg/mL in eluent, sample injection volume 100 μL, sample solutions were filtrated over Chromafil Xtra PTFE (0.20 μm) prior to injection, column PLgel MIXED-E (length 30 cm, diameter 7.5 mm), detector DRI Agilent 1100 series, calibration was done with polystyrene standards with M=266 to M=50400 from Polymer Laboratories. Samples were dissolved in the eluent.

### Comparative Example 1: Deposit Control Additive 5 from EP 1293553, Condensation Product of Tall Oil Fatty Acid and DMAPA

### Example A

A 4 L glass reactor was equipped with a mechanical stirrer and a reflux condenser. A mixture of C20-C24 alpha olefin (958 g, average molecular weight 296 g/mol) and o-xylene (1288 g) was added and heated to 150° C. under stirring and nitrogen. To the reactor maleic anhydride (317 g) and di-tert butyl peroxide (13 g) were added over 5 h. After the addition finished, the mixture was stirred one additional hour and then cooled down to room temperature.

GPC (Method A, evaluation limit 610 g/mol): Mₙ 2430 g/mol, M_{w} 4600 g/mol, D 1.9.

### Example B

A 4 L glass reactor was equipped with a mechanical stirrer and a reflux condenser. C20-C24 alpha olefin (924 g, average molecular weight 296 g/mol) was added and heated to 140° C. under stirring and nitrogen. To the reactor maleic anhydride (306 g) and di-tert butyl peroxide (13 g) were added over 6 h. After the addition finished, the mixture was stirred for one additional hour, diluted with o-xylene (1242 g) and then cooled down to room temperature.

GPC (Method A, evaluation limit 307 g/mol): Mₙ 3730 g/mol, M_{w} 14700 g/mol, D 3.9.

### Example C

A 4 L glass reactor was equipped with a mechanical stirrer and a reflux condenser. A mixture of C20-C24 alpha olefin (466 g, average molecular weight 296 g/mol) and C12 alpha olefin (605 g) was added and heated to 150° C. under stirring and nitrogen. To the reactor maleic anhydride (500 g) and di-tert butyl peroxide (16 g) in C12 alpha olefin (49 g) were added over 6 h. After the addition finished, the mixture was stirred for one additional hour, diluted with o-xylene (1635 g) and then cooled down to room temperature.

GPC (Method A, evaluation limit 307 g/mol): Mₙ 2780 g/mol, M_{w} 8630 g/mol, D 3.1.

### Example D

A 4 L glass reactor was equipped with a mechanical stirrer and a reflux condenser. A mixture of C20-C24 alpha olefin (1157 g, average molecular weight 296 g/mol) and o-xylene (1555 g) was added and heated to 150° C. under stirring and nitrogen. To the reactor maleic anhydride (383 g) and di-tert butyl peroxide (16 g) were added over 3 h. After the addition finished, the mixture was stirred for one additional hour and then cooled down to room temperature.

GPC (Method A, evaluation limit 307 g/mol): Mₙ 1730 g/mol, M_{w} 4750 g/mol, D 2.7.

### Example E

A 4 L glass reactor was equipped with a mechanical stirrer and a reflux condenser. A mixture of C20-C24 alpha olefin (462 g, average molecular weight 296 g/mol), polyisobutene with an average molecular weight of 1000 g/mol (Glissopal® 1000 from BASF) (669 g), and o-xylene (134 g) was added and heated to 150° C. under stirring and nitrogen. To the reactor maleic anhydride (219 g) and di-tert butyl peroxide (28 g) were added over 4 h and 4.5 h, respectively. After the addition finished, the mixture was stirred for one additional hour, diluted with o-xylene (1242 g) and then cooled down to room temperature.

GPC (Method A, evaluation limit 307 g/mol): Mₙ 2040 g/mol, M_{w} 6040 g/mol, D 3.0.

### Example 1

500 g (0.63 mol) of Example A was mixed with DMAPA (65.4 g, 0.64 mol) and heated to 150° C. for 18 h. Liberated water was removed using a Dean-Stark trap. Imide formation was confirmed by ATR-IR (attenuated total reflection, 1699 cm⁻¹ for C═O absorption). Xylene was removed by distillation. Quantitative gas chromatography of the product thus obtained showed residual DMAPA content of 3%.

### Example 2

400 g (0.50 mol) of Example A were mixed with DMAPA (40.3 g, 0.394 mol) and heated to 155° C. for 14 h. Liberated water was removed using a Dean-Stark trap. Imide formation was confirmed by ATR-IR (1699 cm⁻¹ for C═O absorption). Xylene was removed by distillation. Liquid chromatography of the product thus obtained showed residual DMAPA content of <30 ppm.

GPC (Method B, evaluation limit 261 g/mol): Mₙ 1970 g/mol, M_{w} 5390 g/mol, D 2.7.

### Example 3

567 g (0.72 mol) of Example B were mixed with DMAPA (71.5 g, 0.7 mol) and heated to 155° C. for 14 h. Liberated water was removed using a Dean-Stark trap. Imide formation was confirmed by ATR-IR (1699 cm⁻¹ for C═O absorption). Liquid chromatography of the product thus obtained showed residual DMAPA content of 0.018%. Solid content 57.7%, total base nitrogen 68.4 mg KOH/g.

### Example 4

567 g (0.72 mol) of Example D were mixed with DMAPA (71.5 g, 0.70 mol) and heated to 155° C. for 5 h. Liberated water was removed using a Dean-Stark trap. Imide formation was confirmed by ATR-IR (1699 cm⁻¹ for C═O absorption). Liquid chromatography of the product thus obtained showed residual DMAPA content of 0.16%. Solid content 53.7%, total base nitrogen 67.2 mg KOH/g.

### Example 5

578 g (0.90 mol) of Example C were mixed with DMAPA (92.0 g, 0.90 mol) and heated to 155° C. for 5 h. Liberated water was removed using a Dean-Stark trap. Imide formation was confirmed by ATR-IR (1699 cm⁻¹ for C═O absorption). Liquid chromatography of the product thus obtained showed residual DMAPA content of 0.23%. Solid content 57.3%, total base nitrogen 82.7 mg KOH/g.

### Example 6

309 g (0.25 mol) of Example E were mixed with DMAPA (25.6 g, 0.25 mol) and heated to 155° C. for 5 h. Liberated water was removed using a Dean-Stark trap. Imide formation was confirmed by ATR-IR (1699 cm⁻¹ for C═O absorption). Liquid chromatography of the product thus obtained showed residual DMAPA content of <0.005%.

### Example 7

567 g (0.72 mol) of Example B were mixed with DMAPA (35.8 g, 0.35 mol) and DMEOA (31.2 g, 0.35 mol) and heated to 135-155° C. for 4 h. Liberated water was removed using a Dean-Stark trap. Liquid chromatography of the product thus obtained showed residual DMAPA content of <0.005%. %. Solid content 53.9%, total base nitrogen 54.9 mg KOH/g.

### Example 8

567 g (0.72 mol) of Example D were mixed with DMAPA (35.8 g, 0.35 mol) and DMEOA (31.2 g, 0.35 mol) and heated to 135-155° C. for 3 h. Liberated water was removed using a Dean-Stark trap. Liquid chromatography of the product thus obtained showed residual DMAPA content of <0.005%. %. Solid content 49.6%, total base nitrogen 58.5 mg KOH/g.

### Example 9

578 g (0.90 mol) of Example C were mixed with DMAPA (46.0 g, 0.45 mol) and DMEOA (40.1 g, 0.45 mol) and heated to 131-148° C. for 3 h. Liberated water was removed using a Dean-Stark trap. Liquid chromatography of the product thus obtained showed residual DMAPA content of <0.005%. %. Solid content 53.4%, total base nitrogen 71.6 mg KOH/g.

### Example 10

309 g (0.25 mol) of Example E were mixed with DMAPA (12.8, 0.125 mol) and DMEOA (11.1 g, 0.125 mol) and heated to 138-150° C. for 3 h. Liberated water was removed using a Dean-Stark trap. Liquid chromatography of the product thus obtained showed residual DMAPA content of <0.005%.

Determination of Injector Cleanliness with a Direct Injection Spark Ignition Engine.

According to an internal BASF test procedure, a loaded commercially available four-cylinder direct injection spark ignition engine (1.6 liters cylinder capacity) was run with a commercially available gasoline fuel (according to DIN EN 228) containing 7 volume % of oxygen-containing components, during 50 hours.

In run 1 the fuel did not contain any additive In run 2 the fuel contained 160 ppm by weight of the component of Example 2.

In both runs, the “FR” value was determined. FR is a parameter generated by engine steering, corresponding to the time of the process of injection of the fuel into the combustion chamber. If FR increases during a run, this indicates injection nozzles deposit formation, and the FR value increases with the deposit formation. If FR is kept constant or slightly decreases during a run, this indicates that the injection nozzles stay free of deposits.

The following table shows the FR results of runs 1 and 2:

| | | |
|---|---|---|
| Run 1 (for comparison) | at the beginning: 0% | at the end +6.39% |
| Run 2 (according to | at the beginning 0% | at the end −2.55% |
| the invention) | | |

These results demonstrate a keep clean performance of example 2.

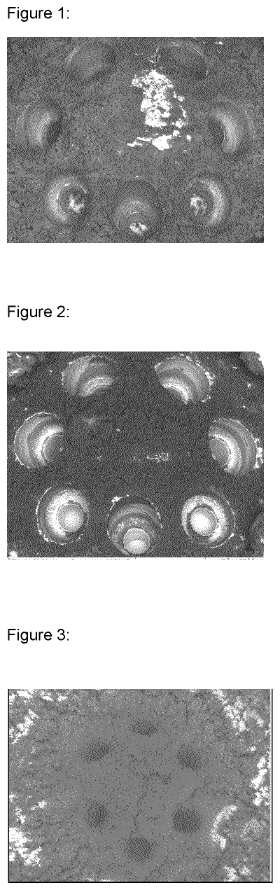

In run 3 the fuel did not contain any additive. At the beginning of the 50 minutes dirty-up phase the FR value was 1.60% and at the end 1.71% indicating injector deposit formation. A SEM picture taken at this stage confirmed deposit formation in the external as well as in the internal injector holes (FIG. 1). In run 4 (clean-up, duration 20 minutes) the fuel contained 40 ppm by weight of the component of Example 2. The injectors from the dirty-up phase after run 3 were used. At the end of the clean-up phase the FR value was −3.74%. A SEM picture taken at this stage (FIG. 2) showed the removal of major parts of the deposits in the internal as well as in the external injector holes compared to the picture taken after the dirty-up.

These results demonstrate a clean-up performance of the compound according to Example 2.

Example 2 was also tested in a preliminary version of the upcoming CEC DISI detergency test (TDG-F-113). The test engine is a VW EA111 1,4L TSI engine with 125 kW. The test procedure is a steady state test at an engine speed of 2000 rpm and a constant torque of 56 Nm. Nozzle coking is measured as change of injection timing. Due to nozzle coking, the hole diameter of the injector holes is reduced, and the injection time adjusted by the Engine Control Unit (ECU) accordingly. The injection time in milliseconds is a direct readout from the ECU via ECU control software. Test duration is 48 h. As base fuel without performance additives a EO gasoline fuel compliant to DIN EN 228 from Haltermann Carless (DISI TF Low Sulphur, Batch GJ0203T456, Orig. Batch 4) with the following properties was used:

| | | | Limits | | |
|---|---|---|---|---|---|
| Feature | Units | Results | Minimum | Maximum | Method |
| RON (*¹) | | 98.8 | 98.0 | — | DIN EN ISO 51642014-10 |
| MON (*¹) | | 87.8 | 87.0 | — | DIN EN ISO 5163:2014-10 |
| Density at 15° C. | kg/m3 | 748.4 | 745.0 | 760.0 | ASTM D4052:2018 |
| DVPE | kPa | 62.3 | 60.0 | 65.0 | DIN EN 13016-1:2018-06 |
| Appearance | — | clear and bright | — | — | Visual |
| Distillation IBP | ° C. | 32.0 | 25.0 | 35.0 | DIN EN ISO 3405:2011-04 |
| Dist. 10% v/v | ° C. | 50.5 | 45.0 | 55.0 | DIN EN ISO 3405:2011-04 |
| Dist. 50% v/v | ° C. | 103.9 | 95.0 | 110.0 | DIN EN ISO 3405:2011-04 |
| Dist. 90% v/v | ° C. | 177.4 | 160.0 | 180.0 | DIN EN ISO 3405:2011-04 |
| Dist. 70 deg C. | % (V) | 27.7 | 22.0 | 50.0 | DIN EN ISO 3405:2011-04 |
| Dist. 100 deg C. | % (V) | 47.3 | 46.0 | 71.0 | DIN EN ISO 3405:2011-04 |
| Dist. 150 deg C. | % (V) | 80.0 | 75.0 | — | DIN EN ISO 3405:2011-04 |
| Distillation FBP | ° C. | 199.1 | 190.0 | 210.0 | DIN EN ISO 3405:2011-04 |
| Dist. Residue | % (V) | 0.7 | — | 2.0 | DIN EN ISO 3405:2011-04 |
| Oxidation Stabilit (*¹) | min. | >1200 | 480 | — | DIN EN ISO 7536:1996-08 |
| Solvent Washed Gum | mg | <1.0 | — | 4.0 | DIN EN ISO 6246:2017-07 |
| | | per 100 mL | | | |
| Aromatics | % (V) | 33.2 | | 35.0 | DIN EN ISO 22854:2016 |
| Olefins | % (V) | 12.9 | 10.0 | 14.0 | DIN EN ISO 22854:2016 |
| Saturates | % (V) | 53.8 | | | DIN EN ISO 22854:2016 |
| Benzene | % (V) | 0.33 | — | 1.00 | DIN EN ISO 22854:2016 |
| Corrosion-Copper | — | 1A max. 1 | — | — | DIN EN ISO 2160:1999-04 |
| Oxygenates | % (V) | 0.1 | — | 0.2 | DIN EN ISO 22854:2016 |
| Hydrogen | % w | 13.19 | | | ASTM D3343:2016 |
| Carbon | % w | 86.81 | | | ASTM D3343:2016 |
| C:H Ratio (H = 1) | | 6.58 | | | ASTM D3343:2016 |
| H:C Ratio (C = 1) | | 0.152 | | | ASTM D3343:2016 |
| Net Heating Value | MJ/kg | 42.824 | | | ASTM D3338:2009 |
| Net Heating Value | Btu/lb | 18410 | | | ASTM D3338:2009 |
| Lead | mg/l | <2.5 | — | 5.0 | ASTM D3237:2017 |
| Sulfur | mg/kg | 4.3 | — | 10.0 | DIN EN ISO 20846:2012-01 |
| Phosphorus (*¹) | g/l | <0.0002 | | 0.0013 | ASTM D3231:2013 |
| Manganese (*¹) | mg/kg | <0.5 | | 2.0 | DIN EN 16136:2015-04 |
| Al (*¹) | mg/kg | <0.1 | — | 0.1 | ICP-OES |
| B (*¹) | mg/kg | <0.1 | — | 0.1 | ICP-OES |
| Ba (*¹) | mg/kg | <0.1 | — | 0.1 | ICP-OES |
| Ca (*¹) | mg/kg | <0.1 | — | 0.1 | ICP-OES |
| Cr (*¹) | mg/kg | <0.1 | — | 0.1 | ICP-OES |
| Cu (*¹) | mg/kg | <0.1 | — | 0.1 | ICP-OES |
| Fe (*¹) | mg/kg | 0.1 | — | 5.0 | ICP-OES |
| Mg (*¹) | mg/kg | <0.1 | — | 0.1 | ICP-OES |
| Mo (*¹) | mg/kg | <0.1 | — | 0.1 | ICP-OES |
| Ni (*¹) | mg/kg | <0.1 | — | 0.1 | ICP-OES |
| Si (*¹) | mg/kg | <0.1 | — | 0.1 | ICP-OES |
| Zn (*¹) | mg/kg | <0.1 | — | 0.1 | ICP-OES |

(*¹) tested by subcontractor
(*²) not accredited
(*³) modified

Test results are summarized in Table 1.

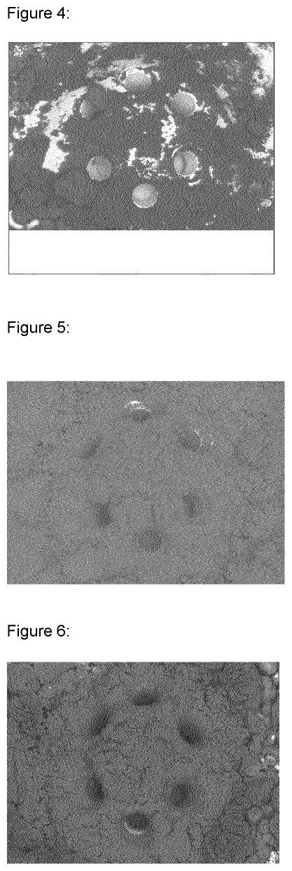

TABLE 1

| | Relative | SEM |
|---|---|---|
| | change of | picture of |
| | Injection | injector tip |
| Test | Time | after test |
| Base run (base fuel without | +8.16% | FIG. 3 |
| performance additives) | | |
| Base fuel additized with | −0.05% | FIG. 4 |
| 81 mg/kg Example 2 | | |
| Base fuel additized with | +5.50% | FIG. 5 |
| 81 mg/kg Comparative | | |
| Example 1 (DCA 5 | | |
| from EP1293553) | | |
| Base fuel additized with 125 | +2.53% | FIG. 6 |
| mg/kg Kerocom PIBA ® | | |

The test results and the pictures show a keep-clean performance of Example 2. They show a performance benefit over Comparative Example 1 and Kerocom PIBA®, the latter one being designed to prevent intake valve deposit formation in port fuel injection engines.

Determination of Storage Stability of a Fully Formulated Gasoline Performance Package

Two gasoline performance packages were formulated according to the following table. 1,3,5-Tris[3-(dimethylamino)propyl]hexahydro-1,3,5-triazine is Deposit Control Additive 1 from EP 1293553. The carrier fluid used is a propoxylated, butoxylated tridecanol derived from trimer-butene (after hydroformylation and hydrogenation). Clear formulations were obtained in both cases.

| | | Formulation 2 |
|---|---|---|
| | Formulation 1 | [wt %] |
| | [wt %] | (Comparative) |
| Kerocom PIBA* | 35.54 | 35.54 |
| Carrier fluid** | 21.42 | 21.42 |
| Nalco 5406 | 2.00 | 2.00 |
| Example 2 | 8.01 | 0 |
| Triazine*** | 0 | 8.01 |
| Hydrosol A200 ND**** | 33.03 | 33.03 |
| Sum | 100 | 100 |

*Kerocom (R) PIBA (65% by weight solution of polyisobutylene amine based on high-reactivity polyisobutene (after hydroformylation and amination), Mn = 1000, in an aliphatic hydro-car-bon mixture)
**propoxylated, butoxylated tridecanol derived from trimerbutene (after hydroformylation and hydrogenation)
***1,3,5-Tris[3-(dimethylamino)propyl]hexahydro-1,3,5-triazine
****solvent

Both formulations were stored at 40° C. to evaluate their storage stability. In case of comparative Formulation 2 the formation of a dark deposit was observed after 5 weeks, whereas inventive Formulation 1 was still clear after 7 weeks. Thus, Formulation 1 according to the invention showed improved storage stability compared to comparative Formulation 2 containing Deposit Control Additive 1 from EP 1293553.

1: A method for controlling injector deposits in a direct injection spark ignition engine, the method comprising:
adding an additive package to a fuel composition,
wherein the additive package comprises a copolymer obtainable by:
(I) copolymerizing
(A) at least one ethylenically unsaturated dicarboxylic acid or a derivative thereof,
(B) at least one α-olefin having from at least 12 up to and including 30 carbon atoms,
(C) optionally, at least one further aliphatic or cycloaliphatic olefin which has at least 4 carbon atoms and is different than (B), and
(D) optionally, one or more further copolymerizable monomers other than monomers (A), (B), and (C), selected from the group consisting of
(Da) vinyl esters,
(Db) vinyl ethers,
(Dc) (meth)acrylic esters of alcohols having at least 5 carbon atoms,
(Dd) allyl alcohols or ethers thereof,
(De) N-vinyl compounds selected from the group consisting of vinyl compounds of heterocycles containing at least one nitrogen atom, N-vinylamides, and, N-vinyllactams,
(Df) ethylenically unsaturated aromatics,
(Dg) α,β-ethylenically unsaturated nitriles,
(Dh) (meth)acrylamides, and
(Di) allylamines,
to obtain a first intermediate copolymer;
(II) reacting the first intermediate copolymer obtainable from (I) with at least one amino compound of formula (I) 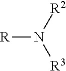
wherein
R is H or a group —R¹—X—H, wherein R¹ is a divalent alkylene group comprising 2 to 6 carbon atoms, optionally interrupted by O, NH, and/or NR⁴ groups, and/or optionally bearing at least one further substituent,
R² and R³ are independently of another C₁-to C₂₀-alkyl, C₆- to C₁₀-aryl, C₅- to C₁₂-cycloalkyl, or C₇- to C₁₁-aralkyl, wherein R² and R³ together with the nitrogen atom may form a cycloaliphatic or aromatic ring in which further hetero atoms may be incorporated,
X is O, NH, or NR⁴, and
R⁴ is C₁- to C₄-alkyl or C₆- to C₁₀-aryl,
to obtain a second intermediate copolymer; and
(III) optionally, partly or fully hydrolyzing anhydride functionalities present in the second intermediate copolymer obtained from (II), to obtain the copolymer.

2: The method according to claim 1, wherein monomer (A) is maleic anhydride.

3: The method according to claim 1, wherein no monomer (C) is present.

4: The method according to claim 1, wherein no monomer (D) is present.

5: The method according to claim 1, wherein R¹ is selected from the group consisting of 1,2-ethylene, 1,2-propylene, 1,3-propylene, 1,4-butylene, 2-methyl-1,2-propylene, 1,5-pentylene, 1,6-hexylene, 1-phenyl-1,2-propylene, and 2-hydroxy-1,3-propylene.

6: The method according to claim 1, wherein R² and R³ are independently of another are C₁-C₄-alkyl.

7: The method according to claim 1, wherein R² and R³ together are 1,4-butylene, 1,5-pentylene, 1,6-hexylene, or 3-oxa-1,5-pentylene.

8: The method according to claim 1, wherein X is NH.

9: The method according to claim 1, wherein the at least one amino compound of formula (I) comprises a mixture of compounds of formula (I), and
wherein the mixture comprises compounds of formula (I) in which X is O and compounds of formula (I) in which X is NR⁴ or NH.

10: An additive package, comprising:
at least one detergent additive selected from the group consisting of
a) polyisobutylene amine with Mₙ 500 to 1500 g/mol,
b) hydrocarbyl substituted primary amine with Mₙ 140 to 255 g/mol,
c) a Mannich reaction product resulting from a reaction of a substituted phenol or cresol with formaldehyde and a primary or secondary amine,
d) an N-quaternary ammonium salt, and
e) a reaction product of a hydrocarbyl-substituted acylating agent and a compound comprising at least one primary or secondary amine group;
at least one further additive selected from the group consisting of carrier oils, cold flow improvers, lubricity improvers, corrosion inhibitors, demulsifiers, dehazers, antifoams, octane number improver, antioxidants, metal deactivators, and solvents; and
at least one copolymer obtainable by:
(I) copolymerizing
(A) at least one ethylenically unsaturated dicarboxylic acid or a derivative thereof,
(B) at least one α-olefin having from at least 12 up to and including 30 carbon atoms,
(C) optionally, at least one further aliphatic or cycloaliphatic olefin which has at least 4 carbon atoms and is different than (B), and
(D) optionally, one or more further copolymerizable monomers other than monomers (A), (B), and (C), selected from the group consisting of
(Da) vinyl esters,
(Db) vinyl ethers,
(Dc) (meth)acrylic esters of alcohols having at least 5 carbon atoms,
(Dd) allyl alcohols or ethers thereof,
(De) N-vinyl compounds selected from the group consisting of vinyl compounds of heterocycles containing at least one nitrogen atom, N-vinylamides, and N-vinyllactams,
(Df) ethylenically unsaturated aromatics,
(Dg) α,β-ethylenically unsaturated nitriles,
(Dh) (meth)acrylamides, and
(Di) allylamines,
to obtain a first intermediate copolymer;
(II) reacting the first intermediate copolymer obtainable from (I) with at least one amino compound of formula (I) 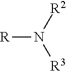
wherein
R is H or a group —R¹—X—H, wherein R¹ is a divalent alkylene group comprising 2 to 6 carbon atoms, optionally interrupted by O, N—H, and/or NR⁴ groups, and/or optionally bearing at least one further substituent,
R² and R³ are independently of another C₁- to C₂₀-alkyl, C₆- to C₁₀-aryl, C₅- to C₁₂-cycloalkyl, or C₇- to C₁₁-aralkyl, wherein R² and R³ together with the nitrogen atom may form a cycloaliphatic or aromatic ring in which further hetero atoms may be incorporated,
X is O, NH, or NR⁴, and
R⁴ is C₁- to C₄-alkyl or C₆- to C₁₀-aryl,
to obtain a second intermediate copolymer; and
(III) optionally, partly or fully hydrolyzing anhydride functionalities present in the second intermediate copolymer obtained from (II), to obtain the copolymer.

11: A gasoline fuel, comprising at least one additive package according to claim 10.

12: A method of operating a spark ignition engine, the method comprising:
introducing into a combustion chamber of a spark ignition engine the gasoline fuel according to claim 11.

13: The method according to claim 1, wherein monomer (A) is an anhydride of a dicarboxylic acid.

14: The method according to claim 1, wherein in the formula (I), R¹ is selected from the group consisting of alkyl, alkyloxy, aryl, hydroxy, amino, and mono- or dialkylated amino group.

15: The method according to claim 1, wherein in the formula (I), R⁴ is methyl.

16: The method according to claim 12, wherein the spark ignition engine is a direct injection spark ignition engine.
